(19) United States
(12) Patent Application Publication
(10) Pub. No.: US 2014/0308094 A1
(43) Pub. Date: Oct. 16, 2014

(54) UNIVERSAL PERFORATION SYSTEM FOR INSTALLATION ON A BINDING OR SPIRAL- BINDING MACHINE CAPABLE OF BINDING USING ANY BINDING SYSTEM

(71) Applicant: Emilio Carlos Lopez Perez, Distrito Federal (MX)

(72) Inventor: Emilio Carlos Lopez Perez, Distrito Federal (MX)

(21) Appl. No.: 14/357,223

(22) PCT Filed: Nov. 9, 2011
(86) PCT No.: PCT/MX2011/000135

§ 371 Date: May 9, 2014

(51) Int. Cl. B42B 9/00

(52) U.S. Cl. CPC B42B 9/00
USPC 412/16

(57) ABSTRACT

The invention relates to a novel industrial product which provides a novel system capable of performing a universal perforation for binding and spiral-binding machines, by means of oblong perforations that receive the rings, spirals or combs and folders with rings of multiple sizes, which is currently performed by machines that involve several steps. Oval perforation punches are installed.

### CROSS REFERENCE TO RELATED APPLICATION

This application is a national stage entry of PCT/MX2011/000135 filed Nov. 9, 2011, under the International Convention.

### FIELD OF THE INVENTION

The present invention relates generally to a new binding or spiral binding system as is generally known and more particularly to a universal biding system that allows to make different binding with different perforations for different binding systems.

### BACKGROUND OF THE INVENTION

The binding systems have more than 50 years with the same perforation formats, which are round, square, rectangular and oval, without substantial changes. This has forced the market in the necessity of having an equipment for each type of required binding, since consumers both in Mexico and the rest of the world require several different types of equipment to meet their needs or the needs of their customers.

Among the known binding systems can be died the spiral binding machines with: double metal ring (steps 3:1 and 2:1) metal spiral (step 3:1, 4:1, 5:1, .2475″, 6 mm), and plastic spiral (steps 3:1, 4:1, 5:1, .2475″, 6mm), and the plastic combs of 6 and 11 tips which are on the market, as well as punchers of 2, 3. 4 or multiple perforations for folders or registrars of different formats. For years consumers of these types of products have increased considerably and they are looking to do more with less and the present equipment summarized the market's request. AH these aforementioned binding systems are unified into a single universal machine with the present technical proposal.

They are incorporated herein as references Mexican applications 9600467 and 9600466, dated Nov. 19, 1966, in which an analysis of the state of the art in terms of spiral binding machines, specifically in terms of the perforation and closing machines of double metallic rings.

In the MU 918 registration issued Aug. 16, 2001, is claimed a spiral binding machine formed by a puncher and a closing for spiral binding with a double metallic ring, which comprises a punching bar having two bars, one with equidistant spaced perforations that receive a series of punches and the other bar of the two bars covers it, and a closing device formed by a closing bar, an actuating lever of both mechanisms, a marimba, a ring holder arranged in the front part of a support platform (page 24). MU 978 registration discloses that a perforation bar which comprises a platform which includes towards the rear section an upper transversal tapper, where is firmly fixed a female bar having an inverted channel shape that linearly presents a series of holes equidistant to each other; over this female bar is arranged in a fixed manner a base bar also perforated (page 8 lines 9 to 14). The MU 1017 registration discloses a spiral binding machine for paper sheets that allows to quickly and efficiently thread perforated sheets into a double metal ring of suitable measuring and closing the ring, a plastic spiral, metallic, or a plastic comb may be used, (page 5, 16-20). MU 1398, discloses a machine with an option of two different perforation diameters, without removing punches like in other machines, including an electric heater for thermal plaster. For more information, it is suggested to consult these prior art documents, whose technique has been developed by the present inventor. Finally, the U.S. Pat. No. 275,441 discloses a spiral binding machine with perforations for two different perforation measurements.

All of the previous technology, can be overcome by the new machine of the present invention, which replaces the different machines used to perform various different binding.

### BRIEF DESCRIPTION OF THE INVENTION

Basically is provided, by way of new industrial product, a spiral binding machine binding that alone makes the work carried out by machines of this type, in binding systems with different perforations.

Obviously, this represents a substantial investment saving in the plurality of machines and also a saving of spaces for such machines, which is very important in homes, private offices, government offices, copy centers, stationery, and printing centers mainly.

Technically, this proposal is based on a principle of respecting all the perforation steps with an OBLONG perforation (longer than wide with rounded ends) but without losing the distances and measures that are currently used by current binding systems.

### DETAILED DESCRIPTION OF THE INVENTION AND THE BEST MODE TO CARRY IT OUT

Now, it will be passed to make a detailed description of the invention given only by way of a non-limiting example, since in view of the drawings and description provided can occur different embodiments without thereby contemplating another invention, since as this disclosure must be considered in its broadest sense and not limited, for example, different machines or similar utilitarian materials, different dimensions, and eventually changes in the perforations, all of which has already been planned.

The invention is described in connection with the accompanying figures in which:

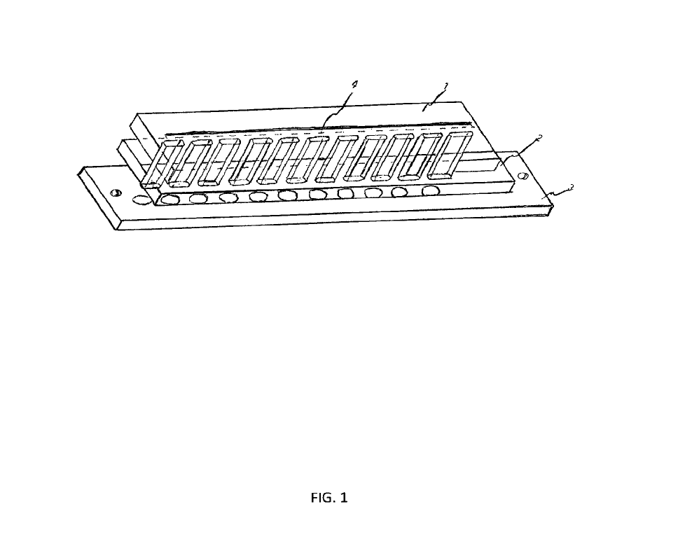

FIG. 1 is a conventional perspective top view and seen from the left side of an oval drilling die, with an oval punch, punch holder, and punch guide that comprises the oval matrix; and

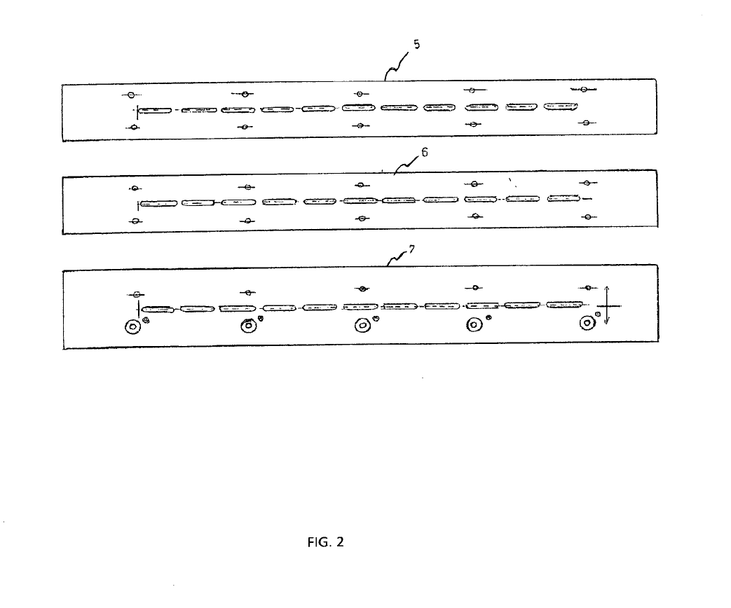

FIG. 2, is a plan view of the comb, guide, and counter, in a respective sequence.

Referring to the figures and particularly to FIG. 1, the oval matrix which is the object of the invention, includes three elongated rectangular platforms (FIG. 1), a first platform (1) punch holder, a second platform (2), of equal size as the previous one, which serves as a punch guide, and a third platform (3) of support with greater dimensions than the previous ones; is provided a row of punches (4) of oval configuration.

Referring now to FIG. 2, shown a top plan view of a comb (5), a guide (6), and a counter (7), perfectly aligned for the respective perforation.

The spaces formed between each of the above mentioned perforations, have equal distances that allow that at the moment of placing the double metal ring, the spiral of any step, either plastic or metal, and the plastic combs or when entering the sheets in folders of 2,3, 4 or multiple rings where needed, to easily enter and results of the binding is optimal.

By way of example, the following is a preferred embodiment (not only) of this essential part of the spiral binding machine and it must be emphasized that this perforate can be mounted practically on a known machine for this purpose, which should be referred to the perforation system which includes the aforementioned devices and the form of perforation.

Platform (1) is about 38.5 cm long, about 4 cm wide, and about 3 mm thick; platform (2) has the same previous measures; and platform (3) has about 48 cm long, about 5 cm wide, and about 3.5 cm thick; the punches have a height of about 3.2 cm, about 4.75 mm wide, and about 22.5 long. The comb and the guide are manufactured of sill (cold rolled) or any other steel and the counter is made of hardened steel or any other type. The holes of the counter (bottom) are countersink for grub screws.

The system uses oval perforations (oblong) through the oval punches (oblong) is the novelty of the invention and not exactly the assembly on a new or conventionally known machine; likewise, can be used an electric drilling and binding machine as the known (or unknown) provided that incorporate the oval punches (oblong) to perform the oblong perforations.

In the above manner, i.e. that only with the application of the oblong perforation, there is no need to change any of the supplies that is now produced in Mexico and other countries of the world and that the customer's investment would only be in the purchase of a single piece of equipment.

Clearly the actual consumer's savings are considerable, both financial and in space, as well as every time that a new system comes out on the market different supplies would have to be bought, as well as, forcing the consumer to have all kinds of different machines and consumables, generating higher costs of production or consumption.

The premise of the proposal is to unite in oblong perforations and thus replace the multiple number of perforations that each perforation step currently requires with each binding system.

As it is easily understood, is overcome with a single equipment the problem of the perforation formats that are round, square, rectangular and oval, that is to say it is not forced to have an equipment for each type of binding required, since to date, the consumers both in Mexico and the rest of the world require multiple pieces of equipment to meet their needs or those of the final customer.

With the present invention, a perforation and binding system is with the same machine that before the present invention had been only a hypothesis for many years by the manufacturers around the world, eliminating major constraints which had been a costly production of each system, for example in Mexico oval perforation for spirals is not manufactured since it is much more expensive than the round one, at the same time that unifying the standard use of metallic or plastic spirals using different steps.

Having described the invention I consider it as a novelty and therefore claim as my property contained in the following clauses:

1-4. (canceled)

5. A perforation system adapted to be install on a spiral binding machine comprising:
an oval matrix having:
a first rectangular platforms,
a second rectangular platform, and
a third rectangular platform,
the first platform carries a punch,
the second platform is a guide punch,
the third platform includes a row of oval perforations.

6. The perforation system of claim 1, wherein the first platform and the second platform have the same dimensions and the third platform have dimensions greater than the dimensions of the first platform and the second platform.

7. The perforation system of claim 1, further including a comb, a guide, an a counter, wherein the comb, the guide, and the counter are aligned to a corresponding oval perforation and allow equidistant spaces between each of the oval perforations.

8. The perforation system according to claim 6, wherein the first and the second platform are about 38.5 cm long, about 4 cm wide, and about 3 mm thick, and wherein the third platform is about 48 cm long, about 5 cm wide, and about 3.5 cm thick.

9. The perforation system according to claim 1, wherein the punch has a height of about 3.2 cm, a width of about 4.75 mm, and a length of about 22.5 mm.

10. The perforation system according to claim 7, wherein the comb is manufactured of steel and wherein the counter includes holes countersunk adapted to receive grub screws.
